(19) United States
(12) Patent Application Publication
(10) Pub. No.: US 2004/0074682 A1
(43) Pub. Date: Apr. 22, 2004

(54) Hybrid powder sources distribution management

(76) Inventors: Peter Michael Fussey, Hove East Sussex (GB); Brian Charles Porter, West Sussex (GB); Jonathan Charles Wheals, Loughborough Leicestershire (GB); Craig Lucas Goodfellow, Crowborough West Sussex (GB)

Correspondence Address: ROSENTHAL & OSHA L.L.P., 1221 MCKINNEY AVENUE, SUITE 2800, HOUSTON, TX, 77010, US

(21) Appl. No.: 10/432,580

(22) PCT Filed: Nov. 21, 2001
(86) PCT No.: PCT/GB01/05155

(30) Foreign Application Priority Data
Nov. 23, 2000 (GB) 0028598.1

(51) Int. Cl. B60K 1/00

(52) U.S. Cl. 180/65.2

(57) ABSTRACT

A hybrid power source includes first and second energy inputs such as an electric motor (14) and an internal combustion engine (20). A power source strategy is implemented in which a cost function is constructed associated with various power distribution options to allows improved distribution of power. For a specific cost (z=constant), the total amount of energy is obtained by integrating during a normalised driving cycle the generating power against time. Thereby a look-up table energy/cost is created.

The invention relates to a vehicle propulsion system and method in particular for a hybrid electrical vehicle (HEV).

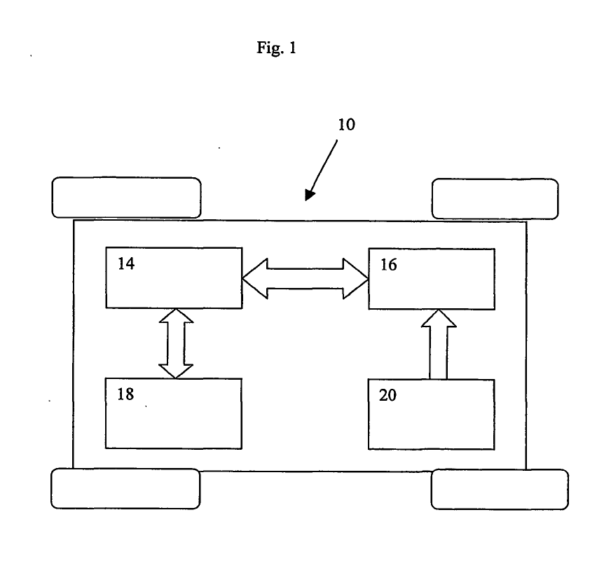

Although hybrid power sources are known the management of energy usage in them is inefficient. For example hybrid electrical vehicles are well known and incorporate two power units and at least one or more stores of fuel or energy; typically the power units comprise an internal combustion engine and an electric machine comprising a motor/generator. In one well known configuration termed a “series” HEV an internal combustion engine is used to generate electricity for storage in a battery and propulsion of the vehicle via a motor/generator. An alternative configuration, the so-called “parallel” HEV is shown schematically in FIG. 1 in a vehicle designated generally 10. The vehicle includes an internal combustion engine 20, an electric motor/generator 14, transmission 16 and a storage device such as a battery 18. The internal combustion engine drives the vehicle 10 through transmission 16. In addition the transmission can also be driven by electric motor 14. Alternatively, when the internal combustion engine is generating excess torque this can be converted to stored electrical energy via transmission 16 and motor/generator 14 operating in generator mode, the electrical energy being stored in battery 18. HEVs of this type are well known and one such is described in U.S. Pat. No. 5,984,033 to Tamagawa.

Known control systems for determining the contribution of each energy source to vehicle propulsion and/or when to generate electrical energy (sometimes termed “regenerative” charging where excess vehicle or internal combustion engine energy is converted to electrical energy) are currently very simple. The principal advantages currently attached to HEV's are those of reduced fuel consumption and emissions and, for example, U.S. Pat. No. 4,042,056 to Horwinski discloses an arrangement in which the transition between propulsion modes is determined based on depression of the accelerator by the user and/or the state of charge of the electric battery.

A more sophisticated arrangement is described in WO 00/15455 to Paice Corporation. According to this disclosure a microprocessor monitors driver input and in particular accelerator or throttle engagement and varies the contribution of the energy sources accordingly, taking into account the vehicle's instantaneous torque requirements, engine torque output and the battery charge based on a set of fixed rules and set points built into, for example, look-up tables. In addition the microprocessor can monitor historical performance and vary subsequent operation accordingly. In parallel to that the system includes intelligent management of an exhaust gas catalytic converter to reduce emissions.

The known systems rely on a rule based strategy that applies a series of rules chosen to keep within the capabilities of the vehicle components or a strategy based on maximising the efficiencies in the system by operating the engine and electric motor/generator at their most efficient points. The known solutions are based around instantaneous minimisation of fuel consumption or maximisation of energy efficiency.

According to the invention there is provided a hybrid power system including first and second energy inputs, first and second respective energy converters, an energy storage device, an energy sink and a power distribution manager wherein the operation of the power system has an associated overall cost which is a function of operational parameters of the power system, and the power distribution manager controls power distribution at an optimum overall cost level.

Thus efficiency is determined on the basis of a range of factors, and a flexible, intelligent control system is achieved.

The energy input may comprise an energy source such as one or more of a chemical (e.g. fuel) or mechanical or electrical energy source such as a rechargeable battery; the energy converter may comprise at least one of an engine such as an internal combustion engine or a fuel cell, the energy storage device which can receive and subsequently return energy to the system may comprise at least one of a battery for example a rechargeable battery, a capacitor, a heat storage device or a flywheel.

Preferably the hybrid power system comprises a vehicle propulsion system. The energy sink may comprise a means by which energy is lost from the system such as at least one of a vehicle driving load, an electrical load, an air conditioning load, an electrical power steering load or a diesel particulate trap regeneration load or other electrical or mechanical loads.

In contrast with known systems in which efficiency is maximised for example by achieving maximum power with minimum fuel consumption, the cost function according to the present invention takes into account the overall operating envelope of the vehicle including driver-induced and environmental factors such as atmospheric emissions loading, topographical influence, the urban environment and so forth. The cost of operating the vehicle to maximise the benefits for an instantaneous or indeed future location of the vehicle may override the demand for instantaneous efficiency. For example the maximum power of the vehicle may be limited or the vehicle may operate under a higher fuel consumption regime to benefit an emissions of DPF regeneration strategy for city use. The vehicle may operate under increased battery power and with a modified exhaust note when passing through environments where vehicle noise must be reduced.

The cost function may be a continuous or substantially continuous function of the parameters.

According to the invention there is further provided a method of managing power distribution in a hybrid power system as claimed in any preceding claim including the steps of assessing an overall cost of a power distribution scheme as a function of operational parameters of the power system and selecting a power distribution scheme at an optimum overall cost level.

According to the invention there is yet further provided a control system for a hybrid power source having first and second power units of different type, at least one of said units being rechargeable by the other unit, the control system controlling operation and recharging of said rechargeable power unit dependent on one or more control values representative of at least one of fuel consumption, exhaust emission, vibration, cabin noise, exterior noise, harshness or load.

The control system preferably controls discharging of said rechargeable energy store when the control value exceeds a benefit limit and the control system preferably controls recharging of said rechargeable energy stores when the control value is less than a cost limit; the benefit limit is preferably a function of the cost limit.

The control value may be compared against a predetermined benefit or cost limit or the control system may receive instantaneous external and/or internal data and the control value may be compared against a benefit or cost limit which is determined based on said external and/or internal data. For example the external data may be geographical data and the internal data may be a battery charge level or ancillary electrical device demand. The cost limit may be based on a predicted future power source load derived from said external or internal data.

In one embodiment said rechargeable unit comprises a battery pack one power unit comprises an electric machine and said other power unit comprises an internal combustion engine.

According to the invention there is further provided a method of controlling a hybrid power source having first and second power units of different type, at least one of said units having a rechargeable energy store rechargeable by said other unit, said method comprising the steps of operating said rechargeable energy store when operation will achieve a net benefit against at least one of fuel consumption, or exhaust emission, or vibration, or noise, or harshness or load and recharging said rechargeable energy store when recharging is achieved up to the cost limit compared to at least one of fuel consumption or exhaust emission, or vibration, or noise, or harshness, or acceleration, or driveability.

According to the invention there is yet further provided a method of calibrating a control system for a hybrid power source, the control system having a data store and the hybrid power source including first and second power units of different type, at least one of said units being rechargeable by said other unit and in which the power source is powered through a plurality of cycles under varying loads, at least one of the control parameters fuel consumption or exhaust emission, or vibration, or noise, or harshness are recorded and stored in said data store and a rechargeable unit operating benefit and recharging cost is derived for each power source load as a function of the recorded control parameter and stored in said data store. As a result cost/benefit limits can be instantaneously derived in a vehicle.

The invention further provides a computer readable medium storing a program for implementing the system and/or methods as described above, a processor configured to carry out instructions to implement the systems and methods as described above, a hybrid power source comprising first and second power units of different type, at least one of said units being rechargeable by said other unit, and a control system as described above and a vehicle including such a hybrid power source.

Embodiments of the invention will now be described, by way of example, with reference to the drawings of which:

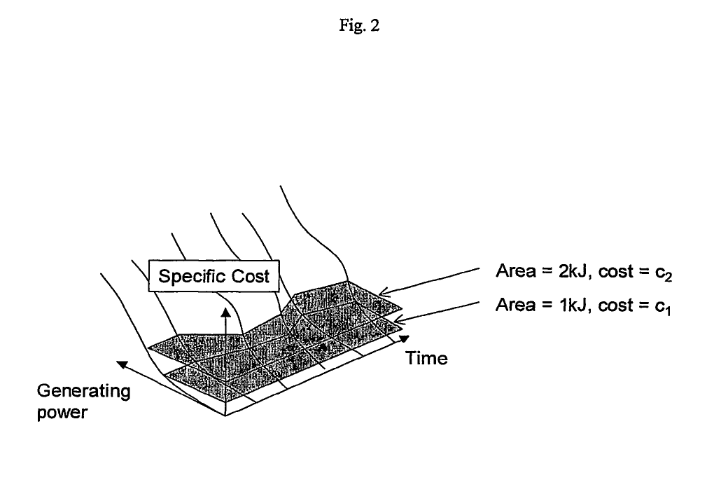

FIG. 2 shows a cost versus power versus time surface according to the present invention;

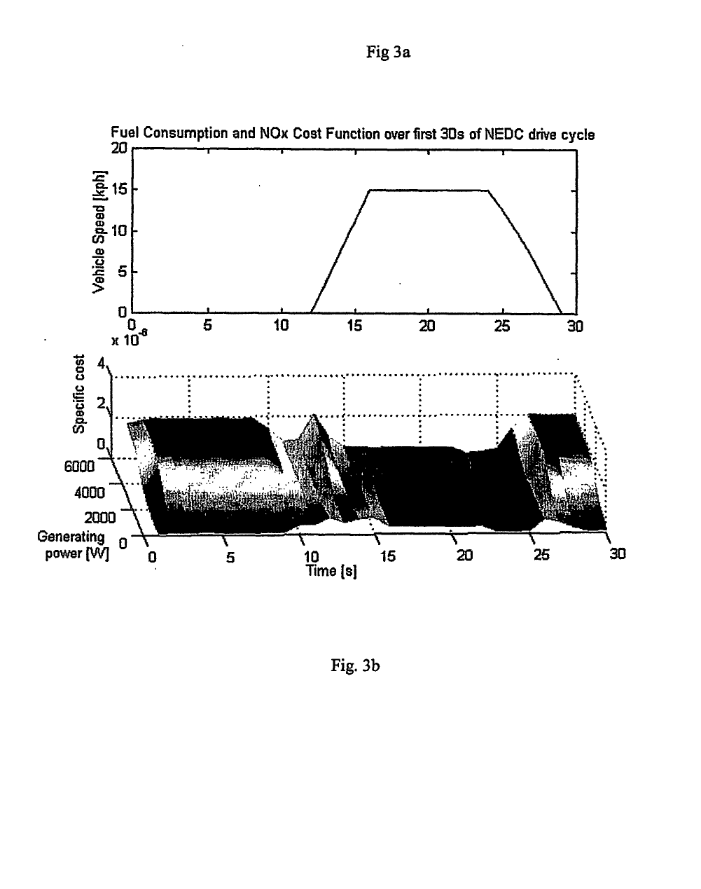

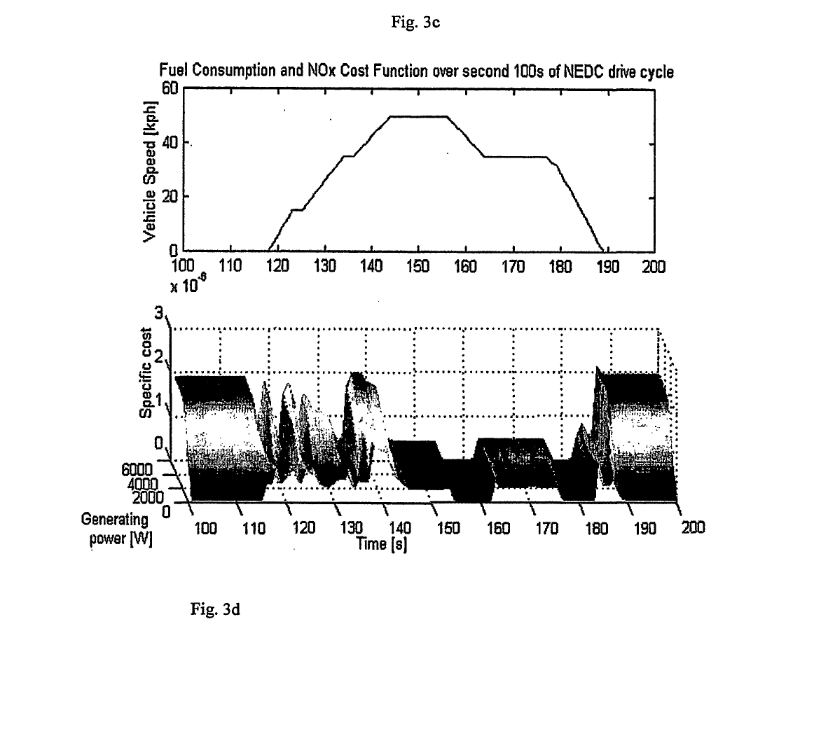

FIG. 3a shows a typical drive cycle;

FIG. 3b shows a cost versus power versus time surface for the drive cycle of FIG. 3a;

FIG. 3c shows an alternative drive cycle;

FIG. 3d shows a cost versus power versus time surface for the drive cycle of FIG. 3c;

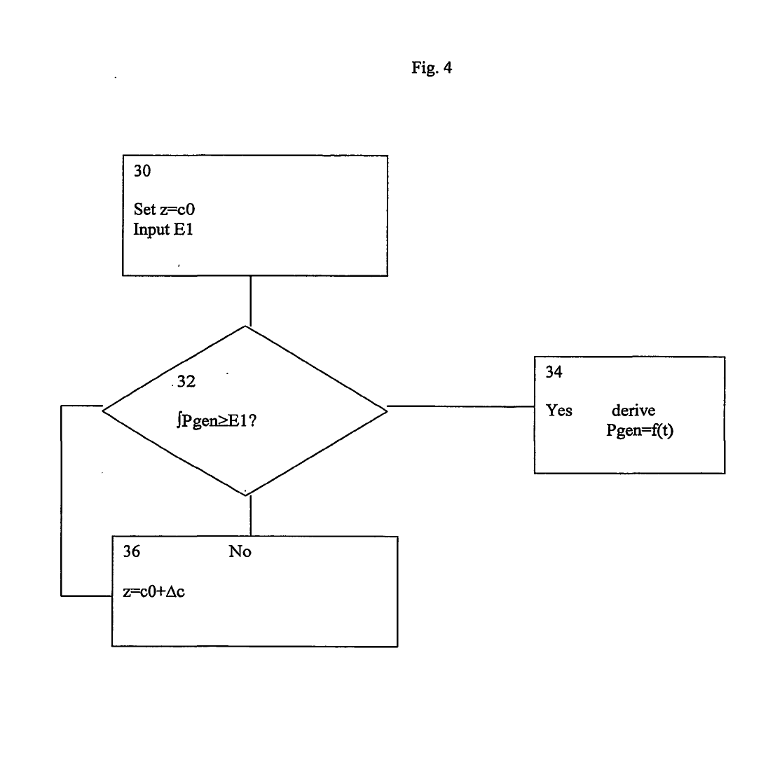

FIG. 4 is a flow diagram showing a calibration routine; and

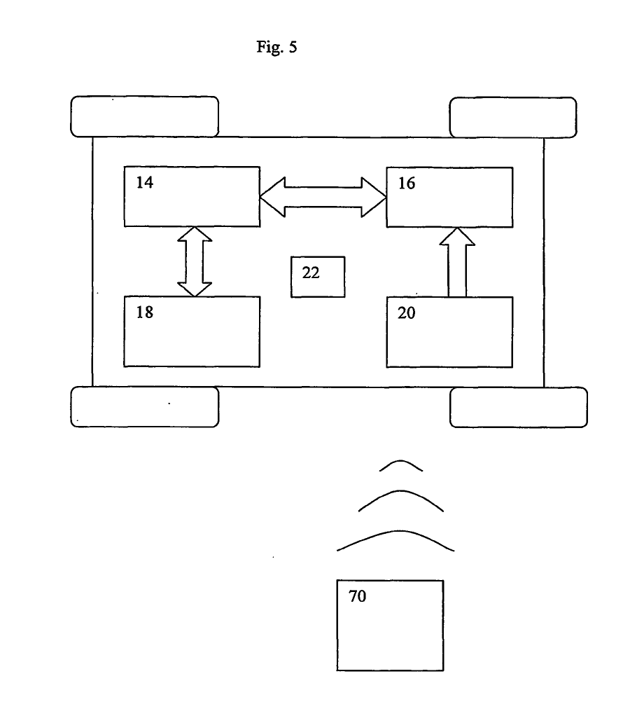

FIG. 5 shows a vehicle according to the present invention in communication with an external information source.

The invention will be described with reference to one preferred implementation in relation to HEV's. The skilled person will be familiar with the energy source/storage and transmission systems of HEV's and of the general interface of these with a control system such that a detailed description of these aspects is not entered into here.

The control system controls a hybrid power source having at least two energy converters comprising an electric machine (motor/generator) and IC engine in the present embodiment and at least one energy store comprising a rechargeable electric battery. These can be viewed as two power units. One input to the control system for an HEV effectively comprises driver demand for an aspect of vehicle performance such as, in particular, acceleration or braking. However demands may also be received from other units which can be viewed as additional energy sinks, for example an air-conditioning unit, a diesel particulate filter or additional ancillary units. Typically a further control parameter is that the vehicle remains capable of charging up electrical energy for the electric machine without recourse to an external recharger, and that the state of charge of the energy store should remain within certain limits. Yet a further parameter might be an instantaneous factor such as non-predicted driver stop. The present invention recognises, however, that within these constraints an intelligent control system can be implemented determining the optimum time and amount of generation of electricity and the optimum instant and amount of energy supplied to the drive and distributed to other components by the electric motor.

In particular the control system of the present invention takes into consideration a range of operational conditions including for example, fuel consumption and/or efficiency of the various HEV power units, rate of exhaust emissions produced, noise, vibration, and harshness (NVH) metrics, drivability or rate of acceleration to provide an overall parameter termed the “objective flimction”. The objective function, which can also be viewed as an overall system cost or “specific cost” can then be minimised over time to optimise the cost of generating electricity and/or the benefit from motoring by controlling the timing, duration and rate of generating/motoring. The objective function can be selected, either for legislative requirements or customer requirements as can be seen from the parameters taken into account.

The key goals are that the electricity should be generated at the cheapest time with reference to the objective function and that electricity should be used for motoring only when the benefit is greater than the cost incurred in generating electricity to replace the electricity used. Accordingly the overall system cost for any mode of operation is assessed whether and when that mode should be implemented or evaluated based on the overall system cost.

The first goal is implemented by always generating up to a given specific cost. This is illustrated in FIG. 2 where the specific cost (z axis) is plotted against generating power and time to give a 3D surface. A lowest cost option is determined dependent upon the amount of energy that requires to be generated. The total amount of energy is obtained by integrating the power against time curve for a given cost (i.e. z=constant). This can be achieved by incrementing the value of the cost (z) axis from 0 until the total integrated in the x-y, power-time plane equals the required energy amount. The lowest cost value is then the corresponding z value. The curve derived at the intersection of the z plane with the 3-D surface represents the optimum variation of generated power against time. FIG. 2 can be viewed intuitively as representing a volume with the x-y plane horizontal and the z plane vertical and a water level rising from z=0, on top of the 3-D surface. When the surface area of the water is equivalent to the desired energy value then the related cost is determined and the optimum power generation versus time curve is formed at the boundary of the water and the 3-D surface. In the example shown in FIG. 2 a first smaller surface area representing 1 kJ of energy is achieved at a cost z=c₁ and a higher value of generated energy of 2 kJ is achieved at a cost z=c₂.

With reference to FIGS. 3a to 3d, operation of the invention in the generating mode can be understood. FIG. 3a represents part of an exemplary drive cycle as determined for the Economic Council for Europe emission test cycle of a vehicle in which it is at rest for approximately 12 seconds, accelerates at a constant rate to attain at about 16 seconds a constant speed of 15 km per hour and then decelerates at approximately 24 seconds at a constant rate to stationary at approximately 29 seconds, in a 30 second cycle.

The control system effectively calculates and consults a series of 2-D curves of specific cost v generating power as the drive cycle progresses to assess the optimum scheme for electrical generation in terms of the “specific cost” of the operation. Preferably the relevant data for generating these curves is derived from calibration results obtained from running the engine type on a test bed and monitoring, for example, emission and fuel consumption for the calibration range of engine loads and speeds. A history of these 2-D curves can be represented as a 3-D surface as shown in FIG. 3b represents a 3-dimensional surface obtained from a plot on 3 axes, the x axis representing the 30 second time interval, the y axis representing electrical generation rate measured in Watts and the z axis the “specific cost” representative of the objective function, all for the drive cycle illustrated.

As can be seen in FIG. 3b a low level of energy generation of the order of a few tens of Watts can be obtained at low cost in the period when the vehicle is stationary and when the vehicle has settled at its cruising speed. In addition low cost generation can be achieved whilst the vehicle is braking, as some of the kinetic energy of the vehicle can be used to generate electricity directly, so called “regenerative braking”. On the other hand, for a fixed point in the drive cycle, for example whilst the vehicle is stationary, the cost of generating electrical energy increases as the generation rate increases. As a rule, costs are particularly high whilst the vehicle is accelerating as electrical generation is simply a further power burden but on the other hand electrical energy generation even at high generation rates can be achieved at low cost during regenerative braking. As a result, when the vehicle is under a specific engine load and speed, the cost of generating can be derived from calibrated values and, as discussed in more detail below, compared to a cost limit to assess whether generation should take place. As discussed in more detail below, this approach is particularly useful in optimising energy management when an upcoming drive cycle can be predicted, for example from real-time external data. FIG. 3d shows the corresponding 3D curve constructed for the drive cycle shown in FIG. 3c.

As an example of how to calibrate i.e. adjust the parameters within a control strategy for a typical driving style, the flow chart in FIG. 4 is used. At step 30 the cost value is set at a lower level z=c₀ and a desired generated energy value E₁ is input. At step 32 the generated power curve P_{gen} is integrated over time. If the integrated value is greater than or equal to the energy input value E₁ then the cost value is the value of z used in step 34. If, however, the desired stored value is not reached then the value is z is incremented by a small value Δc and the process is repeated until the desired value of generated energy is obtained.

In the embodiment discussed above, the “specific cost” value is represented as an absolute figure. In the preferred embodiment the cost represents an objective function combining a measure of a range of parameters into a single value with a combination of, for example, fuel consumption (the higher the fuel consumption the higher the cost) and exhaust emissions (again, the higher the emissions the higher the cost). Of course these variables are preferably normalised and can be combined in any appropriate manner either arithmetically or by a more complex function in order to arrive at a value representative of cost. As a result the vehicle, for a given state (for example accelerating at a given rate and at a given instantaneous velocity) will be operating at a given cost level in terms of the fuel consumption and emission that arise from generating the required power.

The remaining control criteria is when to assist or replace the internal combustion engine with the electric motor, and at what power. As a basic example, if the electric motor is used to assist the internal combustion engine during an acceleration then this will reduce fuel consumption and some of the emission species. Accordingly the strategy for electric motor assist is that it should be used when the benefit (reduction in fuel consumption and emissions) to be gained from motor assist exceeds the cost (increase in fuel consumption and emissions) of generating the electricity. This is implemented by having a second limit, the benefit limit, which can be a function of the cost limit. The electric motor is used to assist or replace the internal combustion engine when the benefit exceeds the benefit limit.

In use therefore, the control system will estimate instantaneously the cost and benefit from generating and motoring respectively. These will be compared to the cost and benefit limits to determine the generating or motoring power.

These limits can either be set for a typical driving style or left as an adaptive limit which can alter if, for example, the battery State Of Charge starts to fall such that the need for generating become more urgent.

In an alternative embodiment, the system sets cost and benefit levels instantaneously dependent on external influences or to adapt to changes in driving style or vehicle usage history. Examples of the external influences are: infrequent use of a high power ancillary such as an air conditioning unit or, in a diesel engine, a particulate trap generation system, or geographic inputs as discussed below.

The geographic inputs can be implemented as shown in FIG. 5. The vehicle includes a control system 22 which controls the power and transmission system and includes a power distribution manager for the power distribution in the vehicle. In addition the controller 22 receives or derives further data concerning the external environment by communication with an external transmitter 70. The external transmitter 70 can be a GPS satellite, a radio or wireless access protocol transmitter or any other suitable form of transmitter. The information derived by the control system 22 may therefore be the instantaneous geographical location of the vehicle or a forecast of impending driving conditions, environment emissions monitoring, street position and time. For example the control system may derive its instantaneous geographical location from the GPS and on that basis establish that it is in an urban or built up area as a result of which emissions should be reduced. On that basis the cost and benefit level for operation of the electric motor should be varied such that the electric motor is used more and the stored energy (e.g. the battery state of charge) is lowered for a period. Alternatively the control system may derive the driving conditions for the next, say, ten miles and on that basis perform a predictive analysis of the burden on the vehicle in that time. As a result it can, for example, modify the cost and or benefit levels to take advantage of future conditions. The cost limit may be raised, however, if the battery charge is sufficiently low such that generation takes place earlier even though a period of operation at lower cost is available in the future. Alternatively the knowledge of the future route may enable the vehicle to operate at maximum power and battery charging capability but at increased emissions over, for example, a rural stretch of road to enable one hundred percent battery operation at limited emissions in an urban environment.

Accordingly it will be seen that the system represented schematically in FIG. 5 can be combined with the stored data and benefit/cost assessment system described with reference to FIGS. 2 to 4 to arrive at an arrangement which provides optimum motoring/generation in an HEV.

The system may further take into account the driving style of the driver. This may be achieved either by presenting the driver with appropriate predetermined options for example “normal”, “sports”, “economy” and continuum. In each case the derivation of the system costs/benefit is performed according to an appropriate predetermined function. Alternatively the driver style can be learnt as an extension of the intelligent system provided by the invention. For example the costs and benefit limits for a driver who drives very slowly will differ from one who drives aggressively, for example reaching a high rev count in each gear. The system can detect behavioural patterns like this and factor them in when assessing costs/benefit projections. The system can store different driving styles for different users who can identify themselves in an appropriate known manner, for example by having separately programmed ignition keys.

An example of how the operation of a known high power ancillary which is occasionally used can be taken into account is now discussed with reference to electrically, powered air conditioning. Consider a vehicle starting a journey in hot weather. The driver switches on the air conditioning which increases the electrical load on the vehicle. The controller increases the cost limit for generating electricity by an amount which over a typical driving pattern will generate sufficient electrical energy to allow the air conditioning to operate. The increase in cost limit can be calibrated as a function of additional power demand.

The DPF (diesel particulate filter) is a device which requires cleaning periodically, this can be achieved using a high power electric heater. The cost from cleaning with the electrical heater is compared against the cost due to increased load on the engine due to back pressure caused by a loaded DPF. The objective function can be used to select an optimum time to clean the DPF. Once it has been decided to clean the DPF the additional generating power can be added to the power calculation by the cost and benefit limits. This is a specific approach for short duration high power electrical loads.

As a further example, in current powertrain and aftertreatment models, catalytic control increases CO₂ emissions by ten to fifteen percent, and emission standards are designed to safeguard city air quality. However unacceptable emissions levels may vary for city and countryside driving typically by 5% to 15% and a location-specific acceptable emissions level can be viewed as an environmental cost forming a further parameter of the objective function. Referring to the system described with reference to FIG. 5, the vehicle control system 22 can receive an emission priority level setting associated environmental cost from a remote station 70 and an emission species weighting transmitted to the vehicle. This can be dependent, for example, on whether the vehicle is involved in country driving, urban driving or motorway driving and the vehicle location can be determined either using GPS (global positioning satellite) or can be simply dependent on the signal broadcast from the remote station which will be appropriate for the locality. As a result the control system 22 can control tailpipe emissions accordingly. As a result, for example, electric motor drive may be implemented more frequently in urban than in country driving.

A further aspect that can be factored into the objective function is a subjective noise, vibration, harshness (NVH) rating for example as a function of engine load and engine speed as a result this will be a further parameter taken into account when the control system assesses which drive mode to adopt.

Yet a further factor that can be controlled by the control system is hybrid engine start/stop. In particular if the duration of the stop can be predicted, the cost of starting can be assessed. If this is less than the benefit of stopping (again comparing the overall costs of each option) the engine can be stopped. The predicted duration can be dependent on, for example, an indication of the vehicle's position in a traffic queue available from a remote station. If the vehicle is near the front of the queue then the cost saving on fuel and emissions, say, achieved by stopping the engine may be outweighed by the enhanced fuel consumption and emissions level if the engine is restarted shortly after it has stopped. A further consideration might be the DPF requirements. For example in heavy traffic the GPS may be aware of traffic information and the vehicle onboard system aware that the DPF is about to require regeneration. Here, where the temperature of the exhaust is low due to the engine loading at low speed or idle in, for example, heavy slow moving traffic, the cabin temperature may also be low. The system may therefore make the decision to apply a stop start regime in traffic as the cost of shutting down and restarting to charge the battery to bring in the DPF heater is too great.

It will be seen, therefore, that the invention provides a system and method where basic components of a vehicle are managed with the objective of minimising the overall cost to undertake a journey. The overall cost is an objective function which can include costs to the driver, (NVH, fuel consumption) and costs to the environment (emissions, NVH. The invention can relate to hybrid vehicles containing at least two power units and at least one rechargeable energy store, but can extend to other power systems as well. The invention can be realised in a controller which instantaneously manages the energy flows in the power units between the energy store or stores and the energy converters according to a comparison of objective function cost with cost and benefit limits. The cost and benefit limits may vary taking into account driver style, the instantaneous demands of high power ancillaries, or the battery or other energy store charge level.

It will be appreciated that the hybrid vehicle can be any type of vehicle including an automobile, bus, truck and so forth. The control system can be implemented in any appropriate manner for example in software or in hardware, for example in the form of a plug-in board attached to the vehicle electronics and existing HEV control. The propulsion units are discussed here as an internal combustion engine and electric motor respectively but it will be appreciated that any appropriate propulsion unit can be introduced and that more than one of each propulsion unit can equally be introduced. Similarly the energy storage unit need not be battery but can be, for example, a mechanical energy storage unit such as a flywheel. It will be further appreciated that the embodiments or aspects of them described above can be combined and interchanged as appropriate.

1. A hybrid power system including first and second energy inputs, first and second respective energy converters, an energy storage device, an energy sink and a power distribution manager wherein the operation of the power system has an associated overall cost which is a function of operational parameters of the power system, and the power distribution manager controls power distribution using an optimum overall cost level.

2. A system as claimed in claim 1 in which the parameters include one or more of energy input consumption, energy sink emission, storage level in the energy storage device, vibration, noise, harshness, power distribution cost and load on the power system.

3. A system as claimed in claim 1 or claim 2 in which the energy input comprises one or more of a chemical, mechanical or electrical energy source such as a rechargeable battery, hydraulic, pneumatic or nuclear.

4. A system as claimed in any preceding claim in which the energy converter comprises at least one of an engine or a fuel cell.

5. A system as claimed in any preceding claim in which the energy storage device comprises at least one of a battery, for example a rechargeable battery, a capacitor, a heat storage device or a flywheel.

6. A system as claimed in any preceding claim comprising a vehicle propulsion system.

7. A system as claimed in claim 6 in which the energy sink comprises at least one of a vehicle driving load, an electrical load, an air conditioning load, an electrical power steering load or a diesel particulate trap regeneration load.

8. A system as claimed in any preceding claim in which the energy storage device is rechargeable by one of said energy converters.

9. A system as claimed in claim 8 in which the operational parameters include the cost of recharging the energy storage device.

10. A system as claimed in any preceding claim in which the operational parameters further include at least one of environmental factors.

11. A system as claimed in any preceding claim in which the overall cost is further a function of predicted or derived future operational parameters.

12. A system as claimed in any preceding claim in which the overall cost is a function of a plurality of operational parameters.

13. A power distribution manager for a hybrid power system as claimed in any preceding claim.

14. A method of managing power distribution in a hybrid power system as claimed in any preceding claim including the steps of assessing an overall cost of a power distribution scheme as a function of operational parameters of the power system and selecting a power distribution scheme at an optimum overall cost level.

15. A method as claimed in claim 11 including the steps of deriving an overall cost associated with a power distribution scheme and comparing the derived cost against an overall cost limit.

16. A method as claimed in claim 12 in which the cost limit is predetermined.

17. A method as claimed in claim 12 in which the cost limit is derived instantaneously.

18. A control system for a hybrid power source having first and second power units of different type, at least one of said units being rechargeable by the other unit, the control system controlling operation and recharging of said rechargeable power unit dependent on more or more control values representative of at least one of fuel consumption, exhaust emission, vibration, noise, harshness, load mechanical durability, system durability or battery durability.

19. A control system as claimed in claim 15 in which the control value is derived based on an instantaneous power source condition.

20. A control system as claimed in claim 15 or 16 in which the control system controls operation of said rechargeable power unit when the control value exceeds a benefit limit.

21. A control system as claimed in any of claims 15 to 17 in which the control system controls recharging of said rechargeable power unit when the control value is less than a cost limit.

22. A control system as claimed in claim 17 and 18 in which the benefit limit is a function of the cost limit.

23. A control system as claimed in claim 15 or claim 16 in which the control value is compared against a predetermined or adaptive benefit or cost limit.

24. A control system as claimed in claim 15 or claim 16 in which the control system receives instantaneous external and/or internal data and the control value is compared against a benefit or cost limit determined based on said external and/or internal data.

25. A control system as claimed in claim 21 in which the cost limit is based on a predicted future power source load derived from said external and/or internal data.

26. A control system as claimed in any of claims 15 to 22 in which said rechargeable unit comprises an electric machine and said other power unit comprises an internal combustion engine.

27. A method of controlling a hybrid power source having first and second power units of different type, at least one of said units being rechargeable by said other unit, said method comprising the steps of operating said rechargeable power unit when operation will achieve a net benefit against at least one of fuel consumption, exhaust emission, vibration, noise, harshness or load by said hybrid power source and recharging said rechargeable power unit when recharging is achieved up to the cost limit compared to at least one of fuel consumption, exhaust emission, vibration, noise, harshness or load.

28. A method as claimed in claim 24 comprising the step of deriving a benefit level associated with operating the rechargeable power unit and comparing the benefit level with a benefit limit to assess whether a net benefit will be achieved.

29. A method as claimed in claim 24 or 25 comprising the steps of deriving a cost level for recharging said rechargeable power unit and comparing said cost level with a cost limit to assess whether the recharging cost is acceptable.

30. A method as claimed in any of claims 24 to 26 in which the benefit limit and/or the cost limit are predetermined.

31. A method as claimed in any of claims 24 to 26 in which the cost limit and/or benefit limit are derived instantaneously.

32. A method of calibrating a control system for a hybrid power source, the control system having a data store and the hybrid power source including first and second power units of different type, at least one of said units being rechargeable by said other unit, in which the power source is powered through a plurality of cycles under varying power source loads, at least one of the control parameters fuel consumption, exhaust emission, vibration, noise, harshness or load are recorded and stored in said data store for each power source load, and a rechargeable unit operating benefit and recharging cost is derived for each power source load as a function of the recorded control parameters and stored in said data store.

33. A method as claimed in claim 29 in which said cost calibration comprises the steps of powering the power source through a plurality of cycles for each of a plurality of recharging rates.

34. A computer readable medium storing a program for implementing power distribution management in a hybrid power system as claimed in any of claims 1 to 9, control system as claimed in any of claims 15 to 23 or a method as claimed in any of claims 11 to 14 or 24 to 30.

35. A processor configured to carry out instructions to implement a power distribution management for a hybrid power system as claimed in any of claims 1 to 9, control system as claimed in any of claims 15 to 23 or a method as claimed in any of claims 11 to 14 or 24 to 30.

36. A hybrid power source comprising first and second power units of different type, at least one of said units being rechargeable by said other unit, and a control system as claimed in any of claims 15 to 23.

37. A vehicle including a hybrid power source as claimed in claim 33.

38. A hybrid power system, control system, vehicle or hybrid power source substantially as herein described and as illustrated in the figures.
